(19) United States
(12) Patent Application Publication
(10) Pub. No.: US 2026/0355594 A1
(43) Pub. Date: Nov. 12, 2026

(54) Display Arrangement for Sports Games

(71) Applicant: Goal Post Marketing (PTY) LTD, Pretoria (ZA)

(72) Inventors: Elcardo Randall Theunis, Somerset West Western Cape (ZA); Andries Johannes Herbst, Somerset West Western Cap (ZA); Ivan Moolman, Somerset West Western Cape (ZA)

(73) Assignee: Goal Post Marketing (PTY) LTD, Pretoria (ZA)

(21) Appl. No.: 19/672,387

(22) Filed: May 8, 2026

(30) Foreign Application Priority Data
May 8, 2025 (ZA) 2025/03901

(51) Int. Cl. A63B 63/08; A63B 71/06; G06F 3/14; G06F 3/147

(52) U.S. Cl. CPC A63B 63/083; A63B 71/0605; A63B 71/0622; G06F 3/1446; G06F 3/147; A63B 2220/802; A63B 2220/805; A63B 2220/806; A63B 2220/833; A63B 2225/54

(57) ABSTRACT

Aspects of the present invention are directed toward a basketball backboard incorporating a transparent display disposed on the back side of the playing surface of the backboard. The display maintains regulation transparency during game play, while displaying visual content during breaks in game play. A sensor mounted on the backboard or hoop detects scoring events by detecting the ball passing through the hoop, analyzing the trajectory of the ball and/or net deformation. Upon detection, a programmed controller automatically triggers output of content on the transparent display.

### CROSS REFERENCE TO RELATED APPLICATIONS

This Application claims priority to the Republic of South Africa Provisional Patent Application No. 2025/03901 filed May 8, 2025, which is incorporated herein in its entirety.

### FIELD OF THE INVENTION

The present invention relates to display arrangements for use during sports games.

### BACKGROUND OF THE INVENTION

In the game of basketball, points are scored by shooting a ball through a hoop of a basketball goal. The basketball goal includes a backboard, a rim and a net. The combination of the rim and net comprises the hoop. The basketball backboard is commonly transparent to improve visibility for fans and cameras. Transparent backboards are typically manufactured from tempered glass, acrylic or similar transparent substrates.

The basketball court also typically includes scoreboards, shot clocks and displays arranged about the court. The basketball backboard is one of the most prominent focal points for fans watching the game in person, and on video broadcasts and streaming. Therefore, there is an opportunity to provide visual content on the basketball backboard that fans are regularly focused on.

### SUMMARY OF THE INVENTION

The present invention may best be understood by referring to the following description and accompanying drawings that are used to illustrate embodiments of the present invention directed toward displaying content on a basketball backboard. The basketball backboard features a transparent display panel disposed on the backside of the play surface of the backboard. The display can render content without obstructing player and/or fan sight lines through the backboard. The novel backboard can further include an automated event triggered system including one or more sensors. Upon detection of scoring event by the one or more sensors, a programmed controller automatically triggers output of content on the backboard display, and optionally one or more auxiliary displays mounted along the top and/or side edges of the backboard. The system also supports triggering through one or more communication interfaces. The transparent backboard display advantageously creates significant advertising and engagement opportunities at one of the most visible focal points of the game.

In one embodiment, a basketball goal assembly can include a transparent backboard having a front play surface. A rim is coupled to the front play surface, and a display is coupled to the back surface of the backboard. A controller coupled to the display is configured to switch operation of the display from a transparent mode to a visual content mode and output visual content in the visual content mode aligned with in-game events.

In another embodiment, a basketball goal assembly includes a backboard and rim coupled to the backboard. The backboard includes a transparent playing surface layer, wherein the rim is coupled to a first surface. A display is coupled to a second surface of the transparent playing surface layer opposite the first surface. The display includes a transparent mode and a visual content mode. One or more sensors coupled to the backboard or rim are configured to detect scoring events. A content controller coupled to the one or more sensors and the display is configured to switch the display from the transparent mode to the visual content mode in response to detection of the scoring events.

In yet another embodiment, a method of selectively presenting visual content on a basketball goal assembly includes receiving visual content and detecting scoring events. A display disposed in a basketball backboard can be switched from a transparent mode to a visual content mode in response to detection of the scoring events. The received visual content can be presented in response to detection of the scoring events while the display is in the visual content mode.

### BRIEF DESCRIPTION OF DRAWINGS

Embodiments of the present invention are illustrated by way of example and not by way of limitation, in the figures of the accompanying drawings and in which like reference numerals refer to similar elements and in which:

FIG. 1 shows top, front, side and isometric views of a basketball goal assembly, in accordance with aspects of the present invention.

FIG. 2 shows a basketball backboard, in accordance with aspects of the present invention.

FIG. 3 shows a basketball backboard, in accordance with aspects of the present invention.

FIG. 4 shows a basketball basket, in accordance with aspects of the present invention.

FIG. 5 shows a basketball basket, in accordance with aspects of the present invention.

FIG. 6 shows a basketball basket, in accordance with aspects of the present invention.

FIG. 7 shows top, side and isometric views of an optional auxiliary display, in accordance with aspects of the present invention.

FIG. 8 shows a top, side, end and isometric view of an auxiliary display mount, in accordance with aspects of the present invention.

FIG. 9 shows a basketball goal assembly, in accordance with aspects of the present invention.

FIG. 10 shows a display circuit, in accordance with aspects of the present invention.

FIG. 11 shows a method of selectively presenting visual content on a basketball goal assembly, in accordance with aspects of the present invention.

FIG. 12 shows a basketball goal assembly in a transparent mode, in accordance with aspects of the present invention.

FIG. 13 shows a basketball goal assembly in a visual content mode, in accordance with aspects of the present invention.

FIG. 14 shows a basketball goal assembly in the visual content mode, in accordance with aspects of the present invention.

### DETAILED DESCRIPTION OF THE INVENTION

Reference will now be made in detail to the embodiments of the present invention, examples of which are illustrated in the accompanying drawings. While the present invention will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present invention, numerous specific details are set forth in order to provide a thorough understanding of the present invention. However, it is understood that the present invention may be practiced without these specific details. In other instances, well-known methods, procedures, components, and circuits have not been described in detail as not to unnecessarily obscure aspects of the present invention.

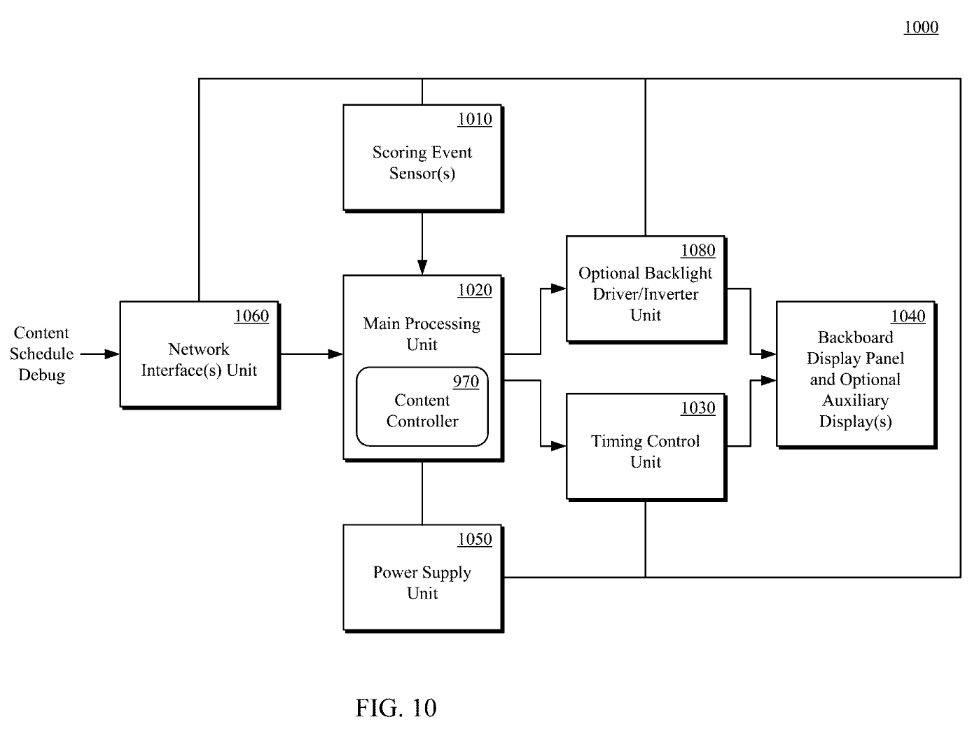

Some embodiments of the present invention which follow are presented in terms of routines, modules, logic blocks, and other symbolic representations of operations on data within one or more electronic devices, see FIG. 10 for instance. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present invention.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present invention, discussions utilizing the terms such as “receiving,” and/or the like, refer to the actions and processes of an electronic device such as an electronic computing device that manipulates and transforms data. The data is represented as physical (e.g., electronic) quantities within the electronic device’s logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and/or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and/or” includes any and all combinations of one or more of the associated elements. It is also to be understood that the phraseology and terminology used herein is for the purpose of description and should not be regarded as limiting.

A basketball backboard, in accordance with aspects of the present invention, integrates a visual display into the basketball backboard. The backboard display allows for the presentation of visual content without obstructing player and/or fan sight lines during game play. An automated event-trigger control architecture includes one or more sensors disposed on the backboard or rim for detecting scoring events. Once a scoring event is detected, a controller can automatically trigger display of visual content on the backboard display. The integrated backboard display advantageously transforms the backboard into a dynamic advertising and engagement zone that responds in real-time to in-game action.

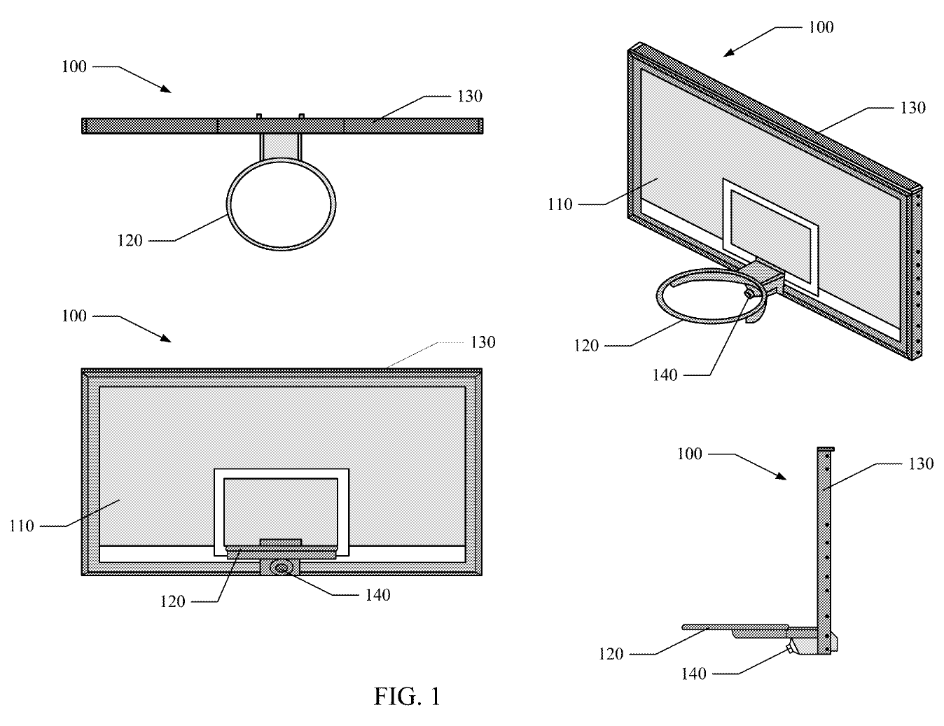

Referring to FIG. 1, top, front, side and isometric views of a basketball goal assembly, in accordance with aspects of the present invention, are shown. The basketball goal assembly 100 includes, but is not limited to, a backboard 110, a rim 120, and a frame 130. The backboard 110 can include a playing surface layer and a display (which is shown and described below with regard to one or more other figures). The rim 120 can be coupled to a first surface of the playing surface layer. The display can be coupled to a second surface of the playing surface layer opposite the rim 120. The backboard 110 can also include a back substrate layer (which is shown and described below with regard to one or more other figures). The back substrate layer can be coupled to the display opposite the playing surface layer.

The playing surface layer and the optional back substrate layer can be manufactured for instance from crystal glass, tempered glass, acrylic or other similar transparent material. The display can be coupled to the playing surface layer using a transparent protective clear film or crystal acrylic film laminated both sides of display. Similarly, the optional back substrate layer can also be coupled to the display using the transparent protective clear film or crystal acrylic film.

The frame 130 is adapted to hold and support the playing surface and display of the backboard 110. The rim 120, also commonly referred to as a hoop, can be coupled to a front surface of the backboard 110, the frame 130 or a combination of the backboard 110 and frame 130.

The display can operate in a range of display modes. In one implementation, the display can operate in a transparent mode and a visual content mode. In transparent mode, the display may be transparent and provide a substantially unobstructed sight line through the backboard 110. In the visual content mode, the display can output content on substantially the entirety of the display, or can provide visual content on a portion of the display with other portions of the display remaining transparent. Providing visual content on a portion of the display with the other portions of the display remaining transparent can for example include displaying a team or company logo with the surrounding remaining portion of the display remaining transparent. Visual content can for example include, but is not limited to, advertisement content, replay content, game score content, cheer animations, team logos, and league logos.

The display can be for instance a transparent light emitting diode (LED) display, transparent holographic display or the like. In an exemplary implementation, the transparent display can be characterized by a mesh structure of LED pixels on a transparent surface. The transparency is achieved by the spacing between pixels. Transparent LED displays can be brighter than other comparable transparent display technologies, making them visible even in bright ambient light environments, and can be utilized for large scale displays. Exemplary transparent displays can include transparent Unitro-Micro transparent LED displays or Unitro 3.9 Holographic Transparent Displays from Unitronics or the like.

The transparent display can output visual content as one or more of two-dimensional (2D) imagery, three-dimensional (3D) imagery, holographic imagery or the like. The transparent display can output visual content in one or more display formats, including but not limited to 4K resolution, 8K resolution or the like. The 4K resolution display format is characterized by a horizontal display resolution of approximately 4096 pixels in one embodiment. The 8K resolution display format is characterized by a horizontal display resolution of approximately 7680 pixels in one embodiment. In one implementation, the transparent display can be adjusted or manufactured to different sizes. The transparent display can be centered widthwise on the backside of the playing surface layer, and toward top edge on the backside of the playing surface layer.

The basketball backboard 110 may have dimensions specified by one or more competition organizations, including but not limited to the National Basketball Association (NBA), National Collegiate Athletic Association (NCAA), and International Basketball Federation (FIBA). In one implementation, the backboard 110 can be approximately 1829 mm wide and 1067 mm high. The basketball goal assembly 100 can meet relevant safety standards, including but not limited to British Standard and European Norm (BS EN) 62262 IK 10 impact rating and Underwriter Laboratory (UL) flame rating. However, the basketball backboard 110 can be of any dimensions and the transparent display can be sized to the transparent area of the basketball backboard 110.

It is appreciated that the basketball goal assembly 100 can also include one or more scoring event sensors 140 and a content controller (not shown in FIG. 1, but shown and described below with regard to one or more other figures). The one or more scoring event sensors 140 can include one or more cameras disposed on or in the rim 120, rim mount, playing surface layer and/or frame of the basketball goal assembly 100. The one or more scoring event sensors 140 are configured to detect scoring events, signals associated with scoring events, or data associated with scoring events at the basketball goal assembly 100. In one implementation, the one or more scoring event sensors 140 can include a camera positioned to detect basketballs passing through the rim. The camera can capture image data and employ a machine vision algorithm to detect the basketball passing through the rim thereby detecting scoring events. Alternatively, the captured image data can be processed by a content controller coupled to the camera to detect the scoring events from the image data. In one implementation, the camera can also capture image data that can be processed to detect additional characteristics, such as but not limited to the characteristic pattern of the basketball, the trajectory of the basketball, and/or deformation of the net attached to the rim 120. The one or more additional characteristics can be utilized to increase the confidence score of the machine learning algorithm of the basketball passing through the rim 120. Alternatively, one or more of the described additional characteristics can be utilized directly to detect basketballs passing through the rim.

The one or more scoring event sensors 140 and/or content controller can be configured to detect the score events in real-time. The scoring event sensors 140 and/or content controller can detect the basketballs passing through the rim within a time frame sufficiently short that the operation appears, from the perspective of users (e.g., players and fans) to occur substantially contemporaneously with the basketball passing through the rim. For instance, real-time detection of scoring events, by the one or more scoring event sensors 140 and/or content controller, can occur in 100 milliseconds (ms) or less.

In another implementation, the one or more scoring event sensors 140 can include an infrared break-beam sensor or the like configured to detect scoring events, signals associated with scoring events, or data associated with scoring events at the basketball goal assembly. The infrared break-beam sensor or a content controller coupled to the infrared break-beam sensor can detect the scoring events from the break-beam signal.

In yet another implementation, the one or more scoring event sensors 140 can include one or more primary sensors and one or more secondary sensors. The one or more primary sensors can be configured to detect the scoring events. The one or more secondary sensors can be configured to increase the confidence in the detection of scoring events by the one or more primary sensors. For example, the one or more scoring event sensors 140 can include a camera and an infrared break-beam sensor. The camera can be configured to detect scoring events, signals associated with scoring events, or data associated with scoring events at the basketball goal assembly. The camera or a content controller can employ a machine vision algorithm to detect the basketball passing through the rim thereby detecting scoring events. The infrared break-beam sensor can also detect scoring events, signals associated with scoring events, or data associated with scoring events. The scoring events, signals associated with scoring events, or data associated with scoring events detected by the infrared break-beam sensor can be utilized to increase the confidence score of the basketball passing through the rim 120 as determined from the scoring events, signals associated with scoring events, or data associated with scoring events captured by the camera.

A content controller can automatically switch the transparent display of the basketball backboard 110 to a visual content mode and output visual content on the display in response to detection of the scoring events. For example, during game play the display can normally be in a transparent mode. The transparent mode provides clear sight lines through the basketball backboard 110 during active game play. After a scoring event, the basketball is taken out-of-bounds and then passed back to a player to resume active game play. In other situations, a foul may be called in the process of a player shooting and scoring. The foul results in the teams lining up accordingly and the referee passing the ball to a player lined up to take the foul shot. In these and other similar situations there is a break or pause in the game play action. During the break or pause, visual content can be displayed on the basketball backboard 110 without distracting players and/or interrupting sight lines of fans in the stadium or watching broadcast or streaming feeds of the game.

The content controller can, upon detection of a scoring event, automatically trigger output of visual content including text and/or images on the transparent display. For example, the content controller can output content such as advertisement content, replay content, game score content, cheer animations, team logos, league logos and the like as soon as a scoring event is detected. The content output on the display of the backboard 110 can be displayed for a predetermined period of time dependent upon the nature of the scoring event, the point of game play and the like. For example, visual content can be automatically displayed as soon as the scoring event is detected and continued for 5 or 10 seconds if the scoring event is a two-point or three-point field goal. If a foul occurs along with the scoring event, display of the visual content can be extended another 5 or 10 seconds. However, if the scoring event occurs within the last minute of the first, second or third quarter, or the last two minutes of the fourth quarter, the content controller may suspend automatically triggering output of visual content on the transparent display of the backboards 110 so as to not distract players and/or interfere with fan sight lines during game play that can have a faster rate of play and/or more critical action. In other situations, a manual trigger can be provided upon a legal touch that resumes game play action to cause the content controller to switch the display back to transparent mode. Other manual triggers can also be provided to the content controller to switch from transparent mode to visual content mode, and/or from visual content mode back to transparent mode. Furthermore, different visual content can be provided based upon a schedule input to the content controller.

The content controller can switch from transparent mode to visual content mode, and/or from visual content mode back to transparent mode automatically. The content controller can switch the display without direct human intervention in response to the predetermined condition, trigger or input. The content controller and/or display can switch from the transparent mode to the visual content mode, and vice versa, by operation of its own internal logic, circuitry or programming, rather than by a manual act performed by a user.

The content controller and/or display can be configured to switch between the transparent mode and the visual content mode in real-time. The content controller and/or display can switch from transparent mode to visual content mode, and/or from visual content mode back to transparent mode within a time frame sufficiently short that the operation appears, from the perspective of users (e.g., players and fans), to occur substantially contemporaneously with detecting the scoring events and/or the basketball passing through the rim. For instance, real-time switching between the transparent mode and the visual content mode, by the content controller and/or display, can occur in 100 milliseconds (ms) or less.

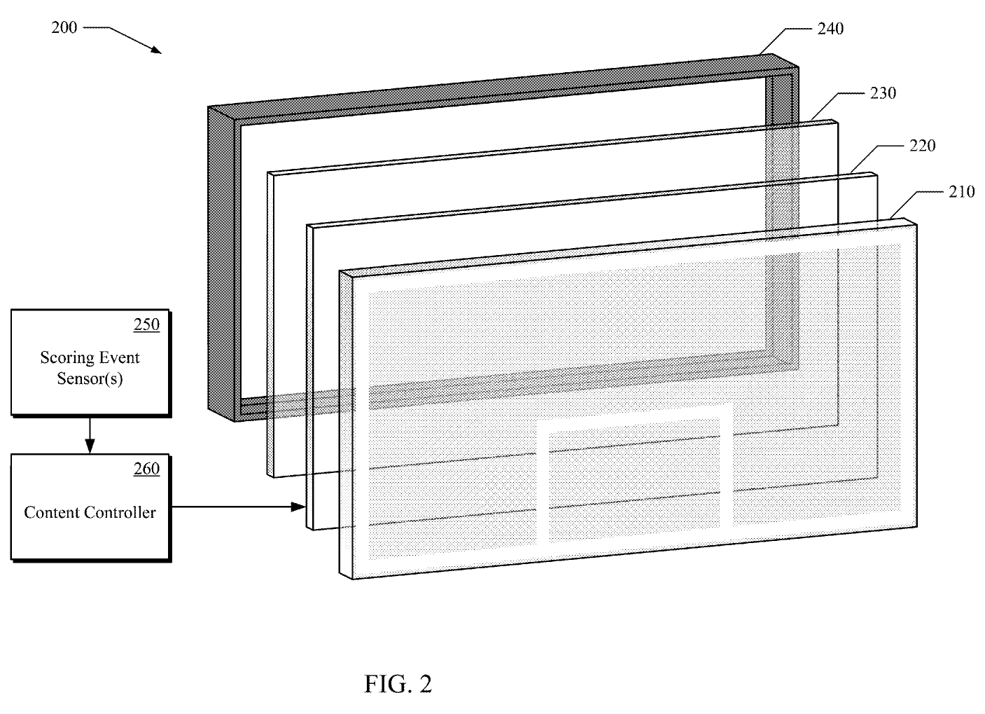

Referring now to FIG. 2, a basketball backboard, in accordance with aspects of the present invention, is shown. The basketball backboard 200 can include a transparent playing surface layer 210, a transparent display panel 220, an optional transparent back substrate layer 230 and a frame 240. The transparent playing surface layer 210, display panel 220, and optional back substrate layer 230 provide clear sight lines through the basketball backboard 200 during active game play in a transparent mode. In a visual content mode, the display panel 220 allows for the presentation of visual content without obstructing player and/or fan sight lines during game play.

The playing surface layer 210 and the optional back substrate layer 230 can be manufactured from crystal glass, tempered glass, acrylic or other similar transparent material. The display panel 220 can be coupled to the backside of the playing surface layer 210. The optional back substrate layer 230 can be coupled to the backside of the display panel 220. The display panel 220 can be coupled to the playing surface layer 210 using a transparent protective clear film of crystal acrylic film to adhere the display panel 220 to the playing surface layer 210. Similarly, the optional back substrate layer 230 can also be coupled to the display panel 220 using the transparent protective clear film of crystal acrylic film to adhere the display panel to the back substrate layer 230.

The frame 240 can be disposed along at least three sides of the basketball backboard 200. For example, in one implementation, the frame 240 can be disposed along the bottom of the backboard 200 and at least a portion of each of the sides of the backboard 200. In another example, the frame 240 can be disposed along a top of the backboard 200 and at least a portion of each of the sides of the backboard 200. In yet another example, the frame 240 can be disposed along the top, bottom and both sides of the backboard 100. The frame 240 is adapted to hold and support the playing surface layer 210, display panel 220 and optional back substrate layer 230 of the backboard 200.

The display panel 220 can be a transparent light emitting diode (LED) display, transparent holographic display or the like. The transparent display panel 220 can output visual content as one or more of two-dimensional (2D) imagery, three-dimensional (3D) imagery, holographic imagery or the like. The transparent display panel 220 can output visual content in one or more display formats, including but not limited to 4K resolution, 8K resolution or the like. The 4K resolution display format is characterized by a horizontal display resolution of approximately 4096 pixels in one embodiment. The 8K resolution display format is characterized by a horizontal display resolution of approximately 7680 pixels in one embodiment. In one implementation, the transparent display panel 220 can be manufactured to different sizes to fit any basketball backboard configuration. In an exemplary implementation, the transparent display panel can be approximately 1710 mm wide, 840 mm high and 5.62 mm thick based on a typical NBA, NCAA, or FIBA basketball backboard. The transparent display panel 220 can be centered widthwise on the backside of the playing surface layer, and toward the top edge on the backside of the playing surface layer 210.

The basketball backboard 200 may have dimensions specified by one or more competition organizations, including but not limited to the NBA, NCAA and FIBA. In one implementation, the backboard can be approximately 1829 mm wide and 1067 mm high. The basketball goal assembly can meet relevant safety standards, including but not limited to British Standard and European Norm (BS EN) 62262 IK 10 impact rating and Underwriter Laboratory (UL) flame rating.

One or more scoring event sensors 250 and a content controller 260 can be coupled to the display panel 220. The one or more of the scoring event sensors 250 and/or the content controller 260 can be disposed on or in the playing surface layer 210, the optional back substrate layer 230 and/or the frame 240. Alternatively, one or more of the scoring event sensors 250 and/or the content controller 260 can be disposed on or in other portions of the basketball goal assembly.

The one or more sensors 250 are configured to detect scoring events, signals associated with scoring events, or data associated with scoring events at the basketball goal assembly. The one or more sensors can include one or more cameras and/or break-beam sensors. Other sensors for detecting the basketball passing through the basketball rim can include photoelectric reflective sensors, smart sensors, RFID sensors, ultrasonic sensors and the like. The photoelectric reflective sensor can emit light in the visible or non-visible spectrum that reflects off the basketball and back to the sensor. Smart sensors can use a sensor in the ball to measure force and spin to determine if a shot was successful. For one implementation, RFID sensors can use a RFID tag in the ball to determine if the ball passes through the rim. Ultrasonic sensors send out sound waves and measure the time it takes for the sound waves to bounce back.

The content controller 260 can be configured to automatically switch the transparent display panel 220 of the basketball backboard 200 to a visual content mode and output visual content on the display panel 220 in response to detection of the scoring events.

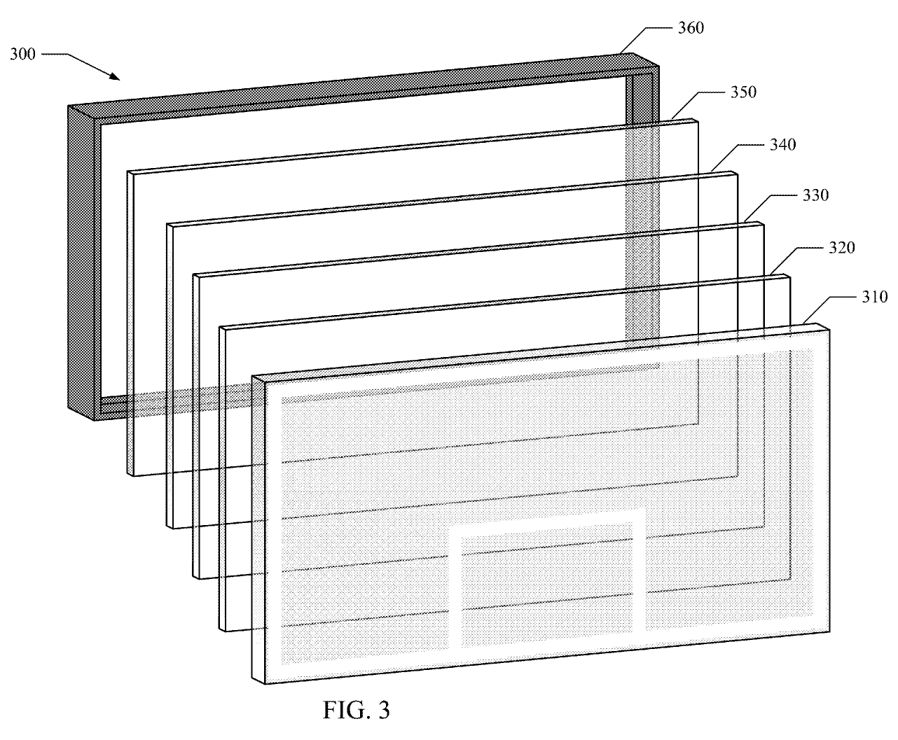

Referring now to FIG. 3, a basketball backboard, in accordance with aspects of the present invention, is shown. The basketball backboard 300 can include a transparent playing surface layer 310, a first transparent display panel 320, a display interposer layer 330, a second transparent display panel 340 an optional transparent back substrate layer 350 and a frame 360. The transparent playing surface layer 310, first display panel 320, display interposer layer 330, second display panel 340 and optional back substrate layer 350 provide clear sight lines through the basketball backboard 300 during active game play in a transparent mode.

In a visual content mode, the display interposer layer 330 is configured to be opaque, enabling the first display panel 320 to project visual content from the frontside of the basketball backboard 300 and the second display panel 340 to project the visual content from the backside of the basketball backboard 300. The display interposer layer 330, the first display panel 320 and second display panel 340 enable the visual content to be presented in proper orientation for viewing respectively from the front and back of the basketball backboard 300. In contrast, the single display panel embodiment described with reference to FIG. 2 presents the content in a laterally inverted orientation when viewed from the backside of the basketball backboard 200.

The first and second display panels 320, 340 for instance can be a transparent light emitting diode (LED) displays, transparent holographic displays or the like. The display interposer layer can be a monolithic transparent liquid crystal (LCD) film or the like, having a transparent state in the transparent mode and an opaque state in the visual content mode.

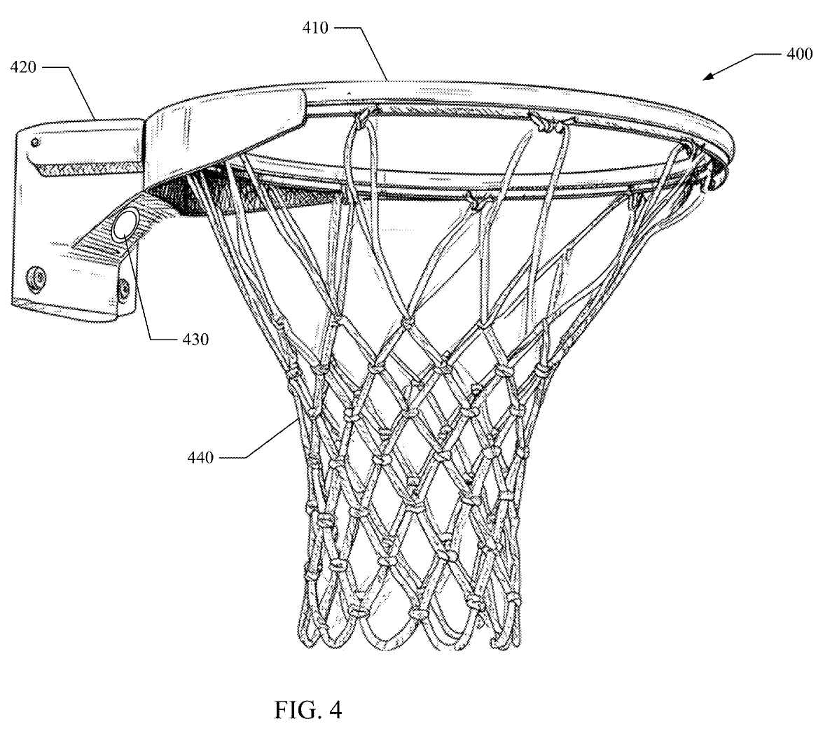

Referring now to FIG. 4, a basketball basket, in accordance with aspects of the present invention, is shown. The basketball basket 400 can include a rim 410, a rim mount 420, one or more sensors 430 and an optional net 440. The one or more sensors 430 can be disposed in or on the rim 410, the rim mount 420 and/or one or more other portions of the basketball goal assembly. In one implementation, the one or more sensors 430 can include a camera disposed in or on the rim 410 or rim mount 420. The camera can be positioned to detect basketballs passing through the rim 410. The camera can capture image data, and the camera and/or a content controller can employ a machine vision algorithm to automatically detect the basketball passing through the rim 410, thereby detecting scoring events. The camera and/or content controller can also detect deformation of the net 440 attached to the rim 410 to augment the detection integrity of the basketball has passed through the rim 410.

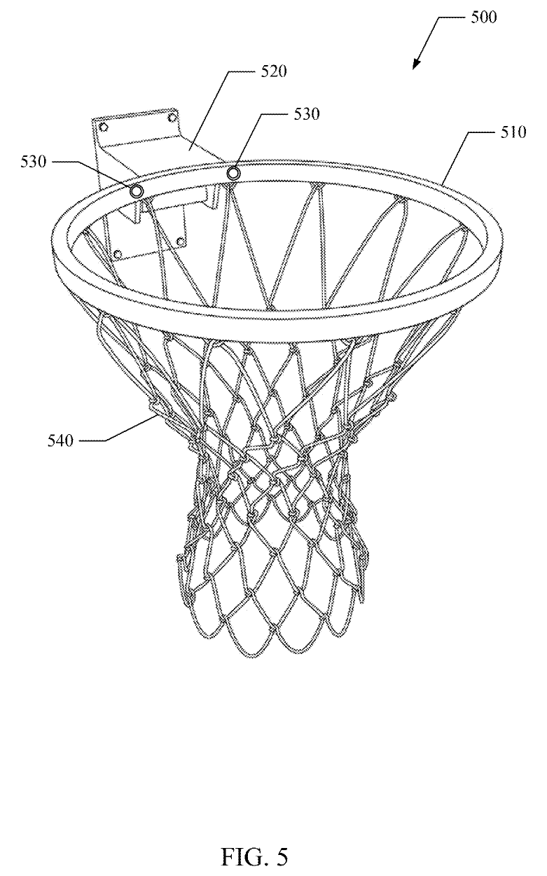

Referring now to FIG. 5, a basketball basket, in accordance with aspects of the present invention, is shown. The basketball basket 500 can include a rim 510, a rim mount 520, one or more sensors 530 and an optional net 540. The one or more sensors 530 can be disposed in or on the rim 510, the rim mount 520 and/or one or more other portions of the basketball goal assembly. In one implementation, the one or more sensors 530 can include one or more break-beam sensors configured to detect scoring events, signals associated with scoring events, or data associated with scoring events at the basketball goal assembly. The break-beam sensor or a content controller coupled to the break-beam sensor can detect the scoring events from the break-beam signal.

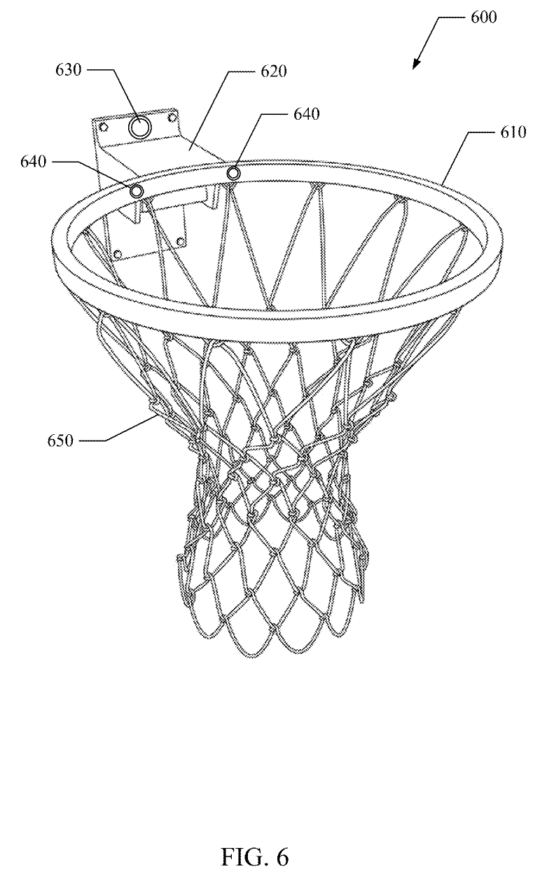

Referring now to FIG. 6, a basketball basket, in accordance with aspects of the present invention, is shown. The basketball basket 600 can include a rim 610, a rim mount 620, one or more sensors 630, 640 and an optional net 650. The one or more sensors 630, 640 can be disposed in or on the rim 610, the rim mount 620 and/or one or more other portions of the basketball goal assembly. In one implementation, the one or more sensors 630, 640 can include one or more primary sensors 630 and one or more secondary sensors 640. The one or more primary sensors 630 can be configured to detect the score events. The one or more secondary sensors 640 can be configured to increase the confidence in the detection of scoring events by the one or more primary sensors. For example, the one or more sensors 630, 640 can include a camera 630 and one or more break-beam sensors 640 disposed in or on the rim 610 or rim mount 620. The camera 630 can be positioned to detect basketballs passing through the rim 610. The camera can capture image data, and the camera and/or a content controller can employ a machine vision algorithm to automatically detect the basketball passing through the rim 610 thereby detecting scoring events. The camera and/or content controller can also detect the trajectory of the basketball to augment detection integrity of the basketball has passed through the rim 610. The one or more break-beam sensors 630 can also be configured to detect scoring events, signals associated with scoring events, or data associated with scoring events at the basketball goal assembly. The one or more break-beam sensors 630 or a content controller coupled to the break-beam sensor utilize the signal generated by the one or more break-beam sensors to augment detection integrity of the basketball has passed through the rim 610.

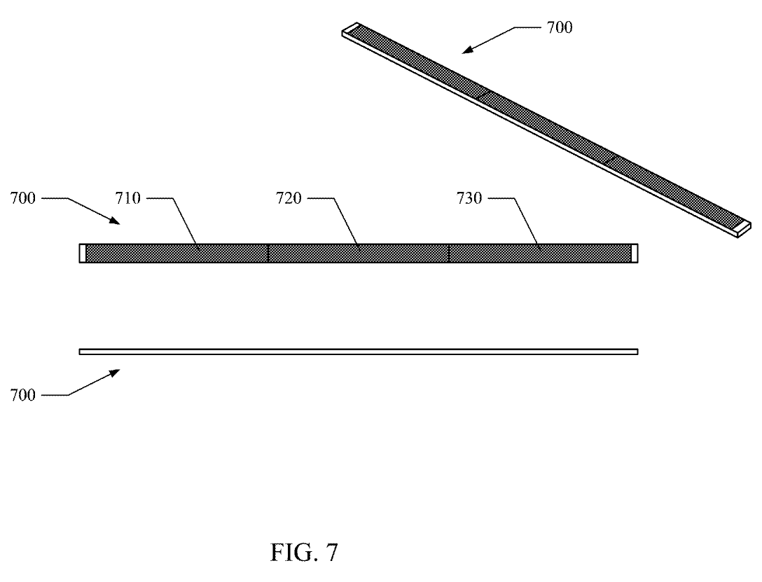

Referring now to FIG. 7, top, side and isometric views of an optional auxiliary display, in accordance with aspects of the present invention, are shown. The auxiliary display 700 can be a display configured to couple to the top and optionally the side and bottom edges of the basketball backboard. The auxiliary display 700 can include one or more display segments 710, 720, 730. The auxiliary display 700 can be a linear ultra-high-definition (UHD) display. The auxiliary display 700 can be approximately 1755 mm wide and 60 mm high, with a resolution of at least 3840 x 2160 pixels and having a brightness of approximately 500 nits, in one example.

Auxiliary displays 700 may, for example, be coupled to the top edge, both side edges and the bottom edge of the backboard. The auxiliary displays 700 can output one or more portions of the visual content, including but not limited to portions of the advertisement content, replay content, game score content, cheer animations, team logos, and league logos output on the transparent display panels, thereby wrapping the advertisement content, replay content, game score content, cheer animations, team logos, and league logos or the like around the edges of the basketball backboard. Alternatively, the one or more auxiliary displays 700 can output banners or other content associated with the visual content presented on the transparent display panels of the basketball backboard. In other implementations, the auxiliary displays 700 can illuminate with red light when the game clock reaches zero (0:00) at the end of each quarter and any overtime period. In another example, an auxiliary display 700 along the top edge of the backboard can illuminate with yellow light when the shot clock expires. In yet another example, an auxiliary display 700 can flash green to indicate that a coach’s challenge has been initiated. In the visual content mode, the one or more auxiliary displays can be utilized to output additional portions of the visual content in combination with the transparent backboard display.

The one or more auxiliary displays 700 can utilize conformal nano-coatings for ingress protection (e.g., IP 65 or better) and can be sealed to withstand high impact ball and player strikes. The auxiliary displays can be coupled to the frame by an anodized aluminum housing for instance.

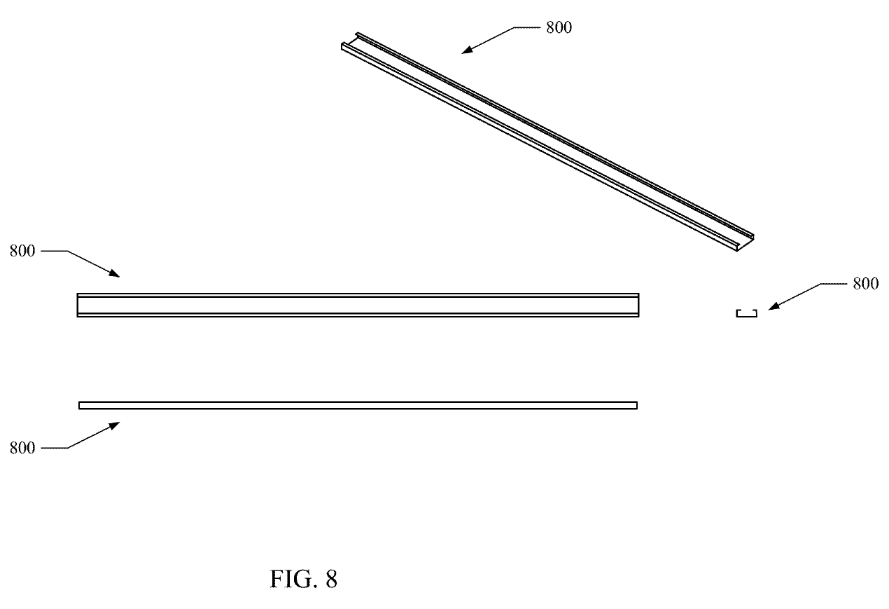

Referring now to FIG. 8, a top, side, end and isometric view of an auxiliary display mount, in accordance with aspects of the present invention, is shown. One or more auxiliary display mounts 800 can be configured to couple one or more auxiliary displays to the basketball goal assembly. The auxiliary display mount 800 in one embodiment can have a c-channel form factor to hold an auxiliary display, including but not limited to those described with reference to FIGS. 1 and 7, along opposing edges of the auxiliary display. In one implementation, the auxiliary display mount 800 may snap over the edges of the auxiliary display to retain the auxiliary display utilizing a friction fit. In another, the auxiliary display may slide into the c-channel of the auxiliary display mount 800 to retain the auxiliary display utilizing a capture fit. In other implementations, fasteners, adhesives or the like can be utilized to couple the auxiliary display to the auxiliary display mount 800. Similarly, fasteners, adhesives or the like can be utilized to coupled the auxiliary display mount 800 to the basketball goal assembly. For example, a double sided adhesive tape can be utilized to secure the auxiliary display mount 800 to the basketball goal assembly.

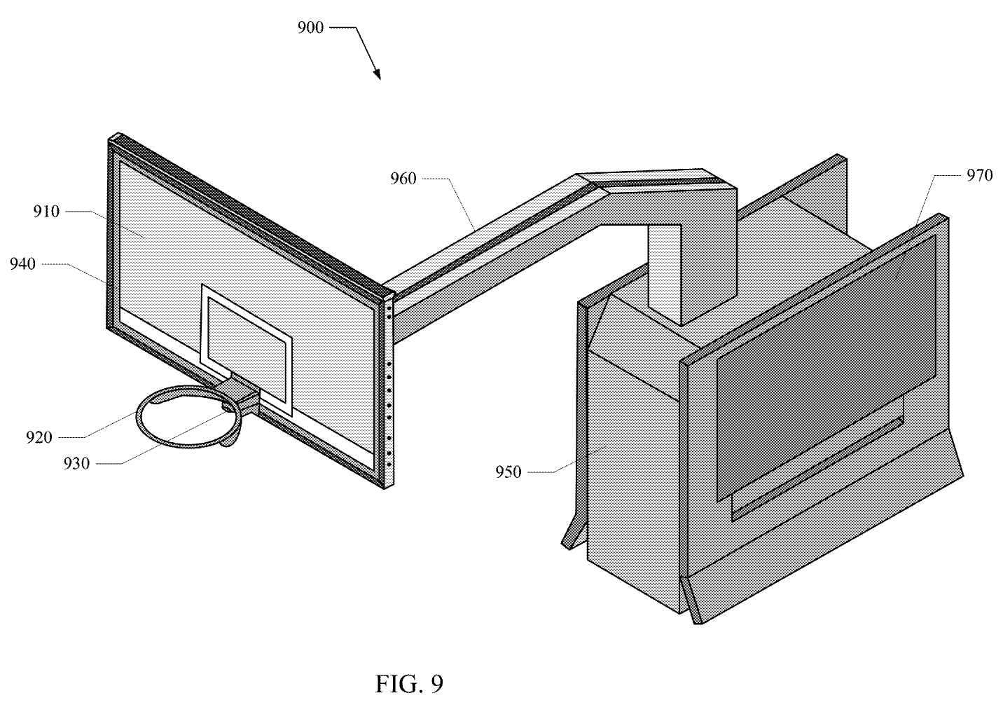

Referring now to FIG. 9, a basketball goal assembly, in accordance with aspects of the present invention, are shown. The basketball goal assembly 900 can include a backboard 910, a rim 920, one or more sensors 930, content controller (not shown), and a frame 940 as described above. The one or more sensors 930 are configured to detect scoring events, signals associated with scoring events, or data associated with scoring events at the basketball goal assembly 900. The one or more sensors 930 can include one or more primary sensors and one or more secondary sensors. The one or more primary sensors can be configured to detect the score events. The one or more secondary sensors can be configured to increase the confidence in the detection of scoring events by the one or more primary sensors, as described above with regard to FIGS. 1 and 4.

The basketball goal assembly 900 can further include a base 950 and frame arm 960. The base functions 950 as a structural foundation, primarily functioning as a counterweight to ensure the basketball goal assembly 900 remains stable and upright. The frame arm 960 is configured to attach between the base 960 and the basketball backboard 910 and/or frame 940. The frame arm 960 supports the basketball backboard 910 to maintain the basketball rim 920 at the specified rim height.

The basketball goal assembly 900 can further include one or more shot clocks, score boards, additional displays 970 and/or the like coupled to the basketball backboard 910, frame 940, frame arm 960, base 950 or the like. Furthermore, the basketball goal assembly 900 can include one or more auxiliary displays, as described above with regard to FIG. 7, to output one or more portions of the visual content, including but not limited to portions of the advertisement content, replay content, game score content, cheer animations, team logos, and league logos output on the transparent display panels, thereby wrapping the advertisement content, replay content, game score content, cheer animations, team logos, and league logos or the like around the edges of the basketball backboard 910.

Referring now to FIG. 10, a block diagram of a display circuit, in accordance with aspects of the present invention, is shown. The display circuit 1000 can include one or more scoring event sensors 1010, a main processing unit 1020, a timing control unit 1030, a backboard display panel 1040 and a power supply unit 1050. Optionally, one or more auxiliary displays may also be included with the backboard display panel 1040.

The power supply unit 1050 can be configured to supply one or more voltage and/or current sources to power the one or more scoring event sensors 1010, the main processing unit 1020, the timing control unit 1030, and backboard display panel 1040. In one implementation, the power supply unit 1050 can be implemented as a power supply printed-circuit board assembly (PCBA). The power supply unit 1050 can be a switched-mode power supply topology delivering regulated 5 volt (V) and 12 V rails for panel drive and logic, and draws a peak power of approximately 500 Watts (W) under full white screen at maximum brightness.

The one or more scoring event sensors 1010 can be configured to detect scoring events, signals associated with scoring events, or data associated with scoring events at the basketball goal assembly. The one or more scoring event sensors 1010 can include one or more cameras, one or more break-beam sensors, or the like. One or more of the scoring event sensors 1010 can be configured as a primary means for detecting scoring events. One or more scoring event sensors 1010 can optionally be configured to augment detection integrity of scoring events detected by the one or more primary sensors. Other sensors for detecting the basketball passing through the rim can include photoelectric reflective sensors, smart sensors, RFID sensors, ultrasonic sensors and the like. The photoelectric reflective sensor can emit light in the visible or non-visible spectrum that reflects off the basketball and back to the sensor. Smart sensors can use a sensor in the ball to measure force and spin to determine if a shot was successful. RFID sensors can use a RFID tag in the ball to determine if the ball passes through the rim. Ultrasonic sensors send out sound waves and measure the time it takes for the sound waves to bounce back.

The main processing unit 1020 can handle input signals from sources like the one or more scoring event sensors 1010, one or more network interfaces 1060 and the like. The main processing unit 1020 can handle video scaling and color calibration, host the operating system and provide smart features of the transparent display subsystem. The main processing unit 1020, the one or more scoring event sensors 1010 or a combination thereof can also perform scoring event detection. In one implementation, the main processing unit 1020, the one or more sensors 1030 or a combination thereof may implement a machine vision algorithm to detect the basketball passing through the rim, thereby detecting scoring events.

In one implementation, the main processing unit 1020 can be implemented as a mainboard printed-circuit board assembly (PCBA). The main processing unit can include an embedded system-on-chip including a processor running an Android Operating System (OS), equipped with Wi-Fi, Ethernet, 4G/5G cellular network, and/or other similar communication interfaces. The main processing unit 1020 can also manage synchronous output to each auxiliary display over low-voltage differential signaling (LVDS).

The main processing unit 1020 can also implement a content controller 1070. The content controller 1070 can, upon detection of a scoring event, automatically trigger output of visual content on the backboard display panel 1040 and optionally one or more auxiliary displays. For example, the content controller 1070 can output content such as advertisement content, replay content, game score content, cheer animations, team logos, league logos and the like as soon as a scoring event is detected.

The optional one or more auxiliary displays can output one or more portions of the content, including but not limited to portions of the advertisement content, replay content, game score content, cheer animations, team logos, and league logos output on the transparent display panels, thereby wrapping the advertisement content, replay content, game score content, cheer animations, team logos, and league logos or the like around the edges of the basketball backboard. Alternatively, the one or more auxiliary displays can output banners or other content associated with the content presented on the transparent backboard display panel. In other implementations, the auxiliary displays can illuminate with red light when the game clock reaches zero (0:00) at the end of each quarter and any overtime period. In another example, an auxiliary display along the top edge of the backboard can illuminate with yellow light when the shot clock expires. In yet another example, an auxiliary display can flash green to indicate that a coach’s challenge has been initiated. In the visual content mode, the one or more auxiliary displays can be utilized to output additional portions of the visual content in combination with the transparent backboard display panel.

The content output on the backboard display panel 1040 can be displayed for a predetermined period of time dependent upon the nature of the scoring event, the point of game play and the like. For example, visual content can be automatically displayed as soon as the scoring event is detected and continued for 5 or 10 seconds if the scoring event is a two-point or three-point field goal. If a foul occurs along with the scoring event, display of the visual content can be extended another 5 or 10 seconds. However, if the scoring event occurs within the last minute of the first, second or third quarter, or the last two minutes of the fourth quarter, the content controller may suspend automatically triggering output of visual content on the transparent display of the backboards so as to not distract players and/or interfere with fan sight lines during game play that can have a faster rate of play and/or more critical action. In other situations, a manual trigger can be provided upon a legal touch that resumes game play action to cause the content controller to switch the display back to transparent mode. Other manual triggers can also be provided to the content controller to switch from transparent mode to visual content mode, and/or from visual content mode back to transparent mode. Furthermore, different visual content can be provided based upon a schedule input to the content controller 1070.

The content controller 1070 can also receive manual trigger commands via a wireless handheld device for switching the backboard display panel 1040 from transparent mode to visual content mode, and/or from visual content mode to transparent mode. The content controller 1070 can also be configured to prioritize visual content for output on the display depending upon the type of scoring event detected.

The timing control unit 1030 can translate video data from the main processing unit 1020 into precise timing instructions for individual pixels. The timing control unit 1030 also controls refresh rates and color synchronization.

The display circuit 1000 can further include one or more network interface units 1060 for receiving the visual content for output on the backboard display panel 1040 under control of the content controller 1070.

The display circuit 1000 can also include optional subcircuits such as, but not limited to, a backlight driver/inverter unit 1080. The backlight driver/inverter unit 1080 can regulate the brightness of an edge light source for illuminating the LCD or LED array of the backboard display panel 1040 and/or optional auxiliary displays. The display circuit 1000 can also include a passive and/or active thermal management unit (not shown) configured to maintain an internal electronics temperature of the display circuit within a range of 0 degrees Celsius (°C) to 70 °C under ambient operating conditions.

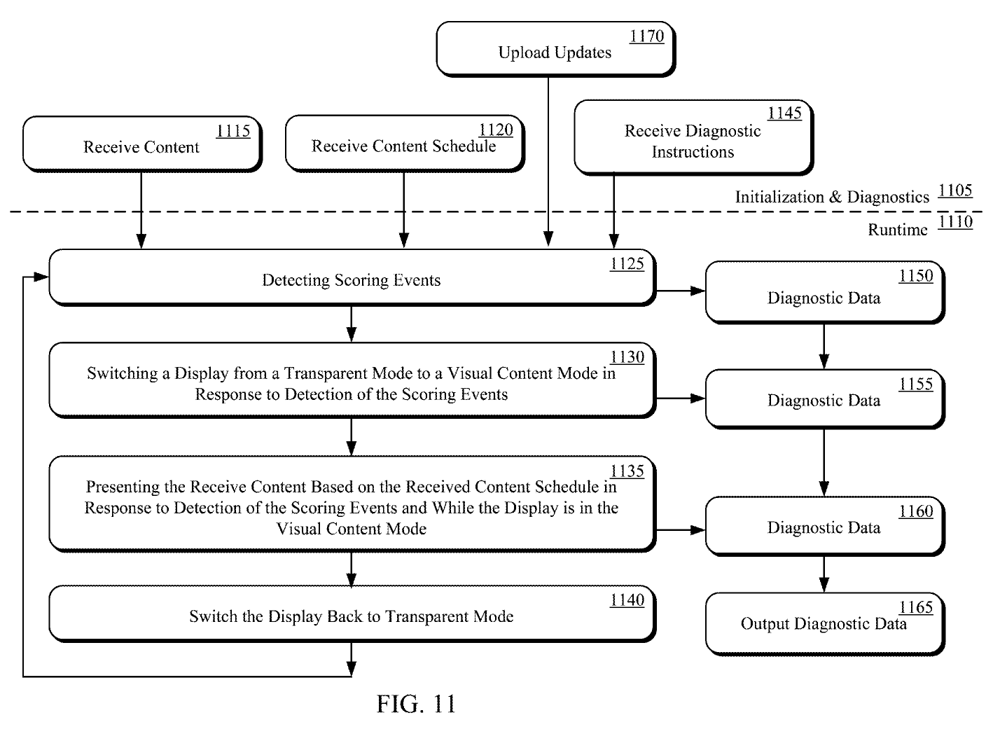

Referring now to FIG. 11, a computing device implemented method of selectively presenting visual content on a basketball goal assembly, in accordance with aspects of the present invention, is shown. The method may be implemented as computing device-executable instructions (e.g., computer program) that are stored in computing device-readable media (e.g., computer memory) and executed by a computing device (e.g., processor). In other implementations, the method can be implemented in firmware or hardware, or any combination of software, firmware and hardware.

The method of selective presenting visual content on a basketball goal assembly can include an initialization and diagnostic phase 1105 and a runtime phase 1110. During initialization, the basketball goal assembly can receive content, at 1115. The content can include advertisement content, replay content, game score content, cheer animations, team logos, league logos and/or the like. The basketball goal assembly can also receive one or more schedules for displaying the received content, at 1120. The one or more schedules can specify which particular received content is output for various scoring events. In one implementation, the Android operating system of a display circuit can expose an application programming interface (API) enabling authorized entities (e.g., advertisers, league operators and teams) to upload media and schedules. The API can also enable monitoring of power consumption, and interrogation of system health metrics. Over-the-air security updates can also be signed and pushed in accordance with Transport Layer Security (TLS) protocols.

During runtime execution 1110, scoring events can be detected by one or more sensors coupled to a basketball backboard and/or basketball rim, at 1125. In one implementation, the one or more sensors can include a camera positioned to detect basketballs passing through the rim. The camera can capture image data and employ a machine vision algorithm to detect the basketball passing through the rim, thereby detecting scoring events. Alternatively, the captured image data can be processed by a content controller coupled to the camera to detect the scoring events from the image data. In one implementation, the camera can also capture image data that can be processed to detect additional characteristics, such as but not limited to the characteristic pattern of the basketball, the trajectory of the basketball, and/or deformation of the net attached to the rim. The one or more additional characteristics can be utilized to increase the confidence score of the machine vision algorithm of the basketball passing through the rim. Alternatively, one or more of the described additional characteristics can be utilized directly to detect basketballs passing through the rim.

In another implementation, the one or more sensors can include an infrared break-beam sensor or the like configured to detect scoring events, signals associated with scoring events, or data associated with scoring events at the basketball goal assembly. The infrared break-beam sensor or a content controller coupled to the infrared break-beam sensor can detect the scoring events from the break-beam signal.

In yet another implementation, the one or more scoring event sensors can include one or more primary sensors and one or more secondary sensors. The one or more primary sensors can be configured to detect the score events. The one or more secondary sensors can be configured to increase the confidence in the detection of scoring events by the one or more primary sensors. For example, the one or more sensors can include a camera and an infrared break-beam sensor. The camera can be configured to detect scoring events, signals associated with scoring events, or data associated with scoring events at the basketball goal assembly. The camera or a content controller can employ a machine vision algorithm to detect the basketball passing through the rim thereby detecting scoring events. The infrared break-beam sensor can also detect scoring events, signals associated with scoring events, or data associated with scoring events. The scoring events, signals associated with scoring events, or data associated with scoring events detected by the infrared break-beam sensor can be utilized to increase the confidence score of the basketball passing through the rim as determined from the scoring events, signals associated with scoring events, or data associated with scoring events captured by the camera.

At 1130, a mode of a basketball backboard display can be automatically switched from a transparent mode to a visual content mode in response to detection of scoring events. In one implementation, a content controller can switch the transparent display of the basketball backboard from a transparent mode to a visual content mode in response to detection of the scoring events.

At 1135, the content received can be presented based on the received content schedule in response to detection of the scoring event and while the display is in the visual content mode. In one implementation, a content controller can, upon detection of a scoring event, automatically trigger output of visual content on a transparent display. For example, the content controller can output content such as advertisement content, replay content, game score content, cheer animations, team logos, league logos and the like as soon as a scoring event is detected. The visual content received during the initialization and diagnostic phase 1105 can be output based on the content schedule received also during the initialization and diagnostic phase 1105. The received content can also be presented on one or more auxiliary displays coupled to the basketball goal assembly in accordance with the received content schedule. For example, the one or more auxiliary displays can output one or more portions of the visual content, including but not limited to portions of the advertisement content, replay content, game score content, cheer animations, team logos, and league logos output on the transparent display panels, thereby wrapping the advertisement content, replay content, game score content, cheer animations, team logos, and league logos or the like around the edges of the basketball backboard. Alternatively, the one or more auxiliary displays can output banners or other content associated with the visual content presented on the transparent display panels of the basketball backboard. In other implementations, the auxiliary displays can illuminate with red light when the game clock reaches zero (0:00) at the end of each quarter and any overtime period. In another example, an auxiliary display along the top edge of the backboard can illuminate with yellow light when the shot clock expires. In yet another example, an auxiliary display can flash green to indicate that a coach’s challenge has been initiated. In the visual content mode, the one or more auxiliary displays can be utilized to output additional portions of the visual content in combination with the transparent backboard display.

At 1140, the display can be switched back to the transparent mode after the visual content has been displayed based upon the received schedule. The process at 1125-1140 can be iteratively repeated for each detected scoring event.

At 1145, one or more diagnostic instructions can be received in an optional process during the initialization and diagnostic phase 1105. The diagnostic instructions can cause diagnostic data to be collected at 1150-1160, in response to the scoring event detection process at 1125, the display mode switching process at 1130, and/or the content presenting process at 1135. The collected diagnostic data and be output and/or analyzed at 1165.

At 1170, updates can also be uploaded to the display circuit of the basketball goal assembly. In one implementation an Android operating system of the display circuit of the basketball goal assembly can enable remote addressability by a uniform resource locator (URL) for content uploading, diagnostics and/or firmware updating.

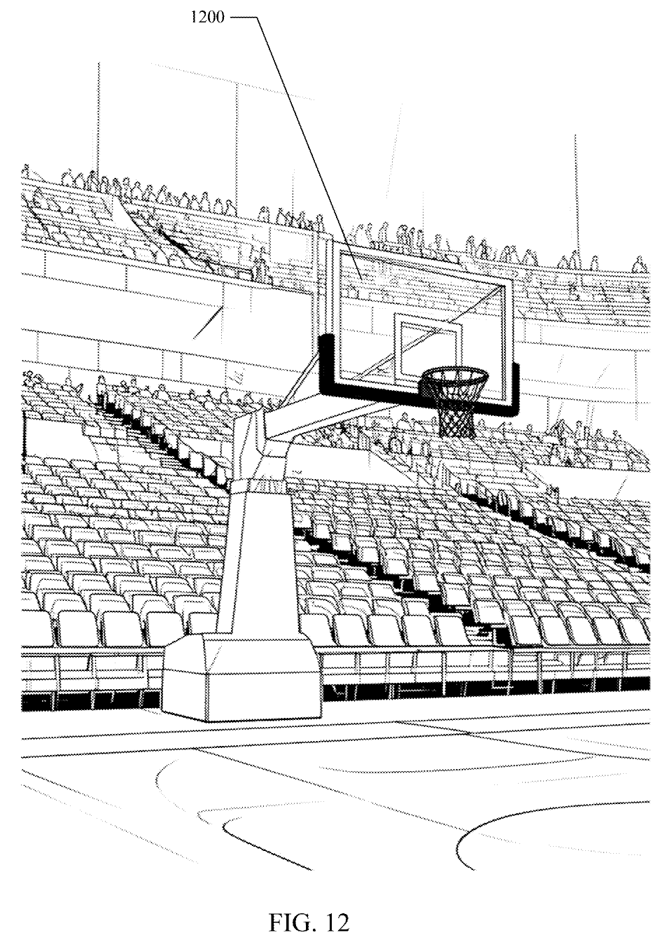

Referring now to FIG. 12, a basketball goal assembly in a transparent mode, in accordance with aspects of the present invention, is shown. In the transparent mode, the display panel of the backboard 1200 is transparent and provides unobstructed sight lines through the basketball backboard for players and fans.

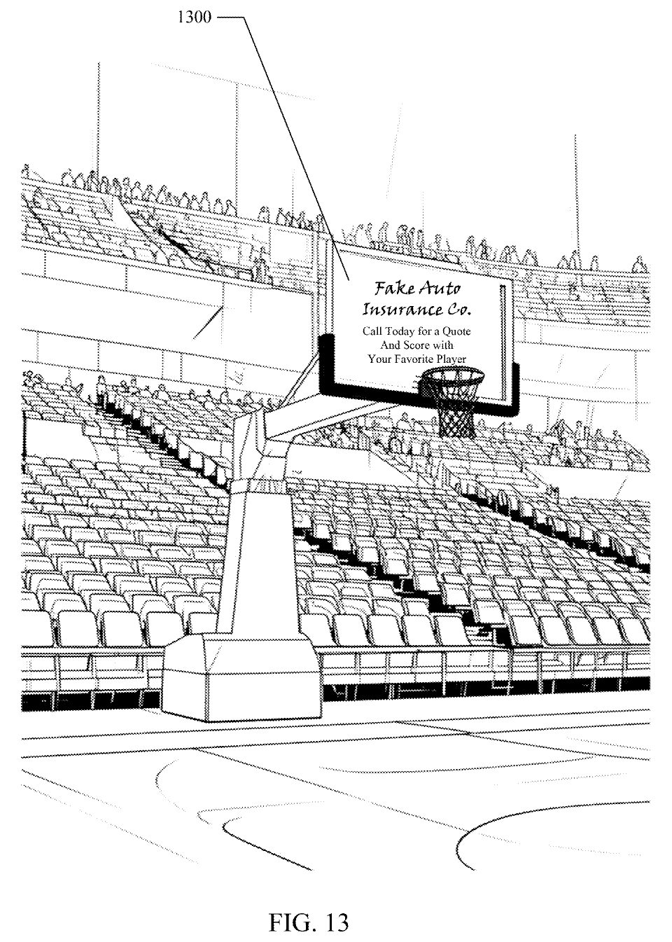

Referring now to FIG. 13, a basketball goal assembly in the visual content mode, in accordance with aspects of the present invention, is shown. In the visual content mode, the display panel 1300 can output visual content that substantially fills the display panel.

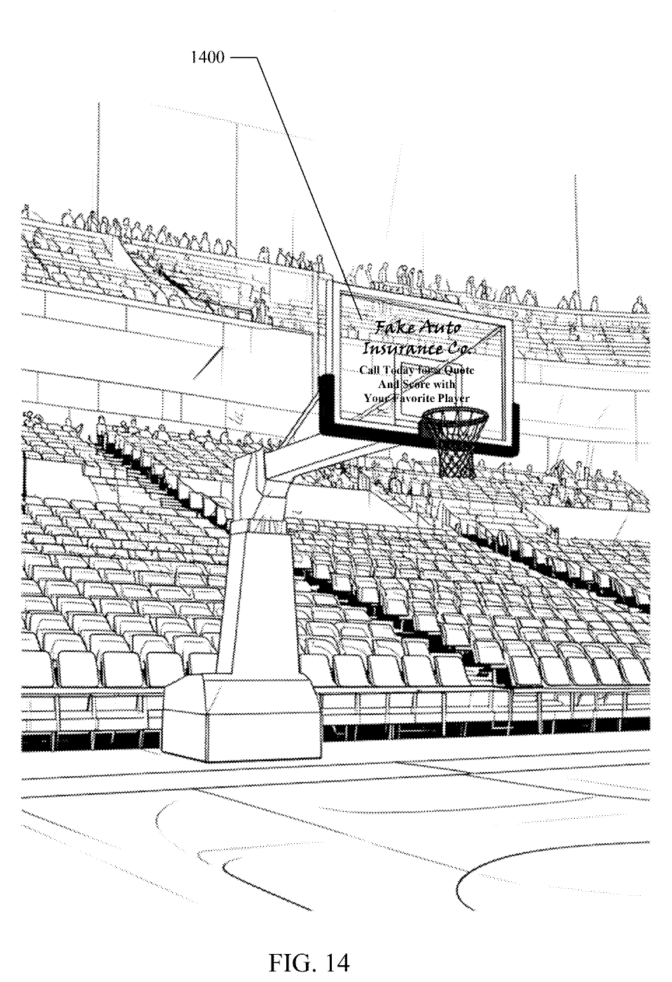

Referring now to FIG. 14, a basketball goal assembly in the visual content mode, in accordance with aspects of the present invention, is shown. In the visual content mode, visual content can be output on a portion of the display panel 1400, while the remaining portions of the display panel remain transparent.

The event-responsive system advantageously transforms the backboard into an intelligent, dynamic advertising and engagement platform while preserving required sight lines and gameplay integrity. Aspects of the present invention advantageously increase the utilization of basketball backboard, and other scoring assemblies in similar sports, to provide visual content such as but not limited to advertisements, replays, and time of play and scoring, cheer animations, team logos, league logos and the like. Aspects of the present invention advantageously integrate display invention into the basketball backboards, without excessive weight, without reducing transparency, without limiting resolution, without reducing durability and the like. Aspects of the present invention advantageously provide a reliable trigger mechanism for switching between different visual content modes aligned with in-game events. Aspects of the present invention can also be readily applied to other games and sports such as slamball that include a backboard and rim.

The following examples pertain to specific technological embodiments and point out specific features, elements, or steps that may be used or otherwise combined in achieving such embodiments.

Example 1 includes a basketball goal assembly comprising: a backboard and a rim coupled to the backboard. The backboard includes; a transparent playing surface wherein the rim is coupled to a first surface of the transparent playing surface; a display coupled to a second surface of the transparent playing surface opposite the first surface of the transparent playing surface, wherein the display is operable between a transparent mode and a visual content mode; one or more sensors coupled to the backboard or rim, wherein the one or more sensors detect scoring events at the basketball goal assembly; and a content controller coupled to the one or more sensors and the display, wherein the content controller switches the display from the transparent mode to the visual content mode in response to detection of the scoring events.

Example 2 includes the basketball goal assembly of Example 1, wherein the content controller switches the display to a visual content mode and outputs visual content on the display in response to detection of the scoring events.

Example 3 includes the basketball goal assembly of any one of Examples 1 and 2, further comprising a net coupled to the rim.

Example 4 includes the basketball goal assembly of any one of Examples 1-3, wherein the display comprises a light emitting diode (LED) display or transparent holographic display.

Example 5 includes the basketball goal assembly of any one of Examples 1-4, wherein the display outputs two-dimensional (2D) imagery, three-dimensional (3D) imagery or holographic imagery.

Example 6 includes the basketball goal assembly of any one of Examples 1-5, wherein the display outputs the visual content in at least 4K resolution.

Example 7 includes the basketball goal assembly of any one of Examples 1-6, wherein the display comprises an active area of approximately 1710 mm in width and 840 mm in height.

Example 8includes the basketball goal assembly of any one of Examples 1-7, wherein the display operates on an Android based operating system providing uniform resource locator (URL) addressability for uploading the visual content.

Example 9 includes the basketball goal assembly of Example 8, wherein uniform resource locator (URL) addressability further provides for firmware updates to the display.

Example 10 includes the basketball goal assembly of any one of Examples 8 and 9, wherein uniform resource locator (URL) addressability further provides for diagnostics of the display.

Example 11 includes the basketball goal assembly of any one of Examples 1-8, wherein the display includes an application programming interface (API) to upload the visual content to the display.

Example 12 includes the basketball goal assembly of Example 11, wherein the display includes the application programming interface (API) to further upload a schedule for displaying the visual content.

Example 13 includes the basketball goal assembly of any one of Examples 11 and 12, wherein the display includes the application programming interface (API) to further download diagnostic data from the display.

Example 14 includes the basketball goal assembly of any one of Examples 1-8, wherein the content controller includes an application programming interface (API) to upload the visual content to the content controller.

Example 15 includes the basketball goal assembly of Example 14, wherein the content controller includes an application programming interface (API) to further upload a schedule for displaying the visual content.

Example 16 includes the basketball goal assembly of any one of Examples 14 and 15, wherein the content controller includes an application programming interface (API) to further download diagnostic data from the content controller.

Example 17 includes the basketball goal assembly of any one of Examples 1-8, 11 and 14, wherein the basketball goal assembly further comprises: a frame disposed at least on a top edge and side edges of the backboard; at least one auxiliary display coupled to the frame along at least one or the top edge and side edges of the backboard, wherein the at least one auxiliary display includes a transparent mode and a visual content mode and wherein the at least one auxiliary display is normally in the transparent mode; and the controller switches the at least one auxiliary display from the transparent mode to the visual content mode in response to detection of the scoring events.

Example 18 includes the basketball goal assembly of Example 17, wherein the at least one auxiliary display coupled to the frame along a top edge of the backboard comprises an active area of approximately 1755 mm in length and at least 60 mm in height.

Example 19 includes the basketball goal assembly of any one of Examples 1-8, 11 and 14, wherein display of the visual content is aligned with in-game events.

Example 20 includes the basketball goal assembly of any one of Examples 1-8, 11, 14 and 19, wherein one or more sensors comprise at least one camera, break-beam sensor, photoelectric reflective sensor, smart sensor, RFID sensor or ultrasonic sensor.

Example 21 includes the basketball goal assembly of any one of Examples 1-8, 11, 14, 19 and 20, wherein the basketball backboard comprises one of transparent crystal glass, transparent tempered glass or transparent acrylic.

Example 22 includes the basketball goal assembly of any one of Examples 1-8, 11, 14 and 19-21, wherein the display is coupled to the transparent playing surface by a transparent protective clear film or crystal acrylic film.

Example 23 includes the basketball goal assembly of Example 22, wherein the backboard further includes a transparent back substrate layer coupled to the display opposite the transparent playing surface layer, wherein the transparent back substrate layer comprises transparent crystal glass, transparent tempered glass or transparent acrylic, and wherein the transparent back substrate layer is coupled to the display by a transparent protective clear film or crystal acrylic film.

Example 24 includes the basketball goal assembly of any one of Examples 1-8, 11, 14 and 19-23, wherein the backboard further includes: the display configured to output the visual content orientated for viewing from the first surface of the transparent playing surface layer; a second display including a transparent mode and a visual content mode, wherein the second display is configured to output the visual content orientated for viewing from a backside of the backboard; and a display interposer layer disposed between the display and the second display, wherein the display interposer layer includes a transparent mode and a visual content mode and wherein the display interposer layer is configured to optically separate the display from the second display during the visual content mode.

Example 25 includes a basketball goal assembly comprising: a transparent backboard having a front play surface; a rim coupled to the front play surface; a display coupled to the transparent backboard opposite the rim; and a controller coupled to the display to switch operation of the display from a transparent mode to a visual content mode and output visual content in the visual content mode aligned with in-game events.

Example 26 includes the basketball goal assembly of Example 25 wherein the display is coupled to the transparent backboard by transparent protective clear film or crystal acrylic film.

Example 27 includes the basketball goal assembly of Example 25, further comprising: one or more primary sensors operable to detect scoring events; and one or more secondary sensors operable to increase confidence in the detection of the scoring events by the one or more primary sensors.

Example 28 includes the basketball goal assembly of any one of Examples 25-27, further comprising: one or more auxiliary displays coupled to one or more sides of the transparent backboard and display; and the controller coupled to the display and the one or more auxiliary displays and operable to output a portion of the visual content on the display and at least one additional portion of the visual content on the one or more auxiliary displays in the visual content mode.

Example 29 includes the basketball goal assembly of any one of Examples 25-28, wherein outputting the visual content aligned with in-game events includes outputting the visual content in response to scoring events.

Example 30 includes the basketball goal assembly of any one of Examples 25-29, wherein the display comprises a light emitting diode (LED) display or transparent holographic display.

Example 31 includes the basketball goal assembly of any one of Examples 25-30, wherein: the backboard further includes one or more sensors coupled to the backboard or rim, wherein the one or more sensors detect scoring events at the basketball goal assembly; and the controller further switches operation of the display from the transparent mode to the visual content mode and outputs the visual content in the visual content mode in response to detection of the scoring events.

Example 32 includes the basketball goal assembly of any one of Examples 25-31, wherein the display outputs one or more of two-dimensional (2D) imagery, three-dimensional (3D) imagery and holographic imagery.

Example 33 includes the basketball goal assembly of any one of Examples 25-32, wherein the display outputs the visual content in at least 4K resolution.

Example 34 includes the basketball goal assembly of any one of Examples 25-33, wherein the display comprises an active area of approximately 1710 mm in width and 840 mm in height.

Example 35 includes the basketball goal assembly of any one of Examples 25-34, wherein the display operates on an Android based operating system providing uniform resource locator (URL) addressability for one or more of uploading the visual content, for providing updates, and for providing diagnostics.

Example 36 includes the basketball goal assembly of any one of Examples 25-35, wherein the display includes an application programming interface (API) for one or more of uploading the visual content, uploading a schedule for displaying the visual content and downloading diagnostic data.

Example 37 includes the basketball goal assembly of any one of Examples 25-35, wherein the content controller includes an application programming interface (API) to upload the visual content, uploading a schedule for displaying the visual content and downloading diagnostic data.

Example 38 includes the basketball goal assembly of any one of Examples 25-27 and 29-37, wherein the basketball goal assembly further comprises: a frame disposed along at least one edge of the backboard; at least one auxiliary display coupled to the frame along the at least one of the top edge of the backboard; and the controller outputs the visual content one the at least one auxiliary display in response to detection of the scoring events.

Example 39 includes the basketball goal assembly of any one of Examples 25-38, wherein display of the visual content is aligned with in-game events.

Example 40 includes the basketball goal assembly of any one of Examples 25, 26 and 38-39, wherein one or more sensors comprise at least one of a camera, a break-beam sensor, photoelectric reflective sensor, smart sensor, RFID sensor or ultrasonic sensor.

Example 41 includes the basketball goal assembly of any one of Examples 25-40, wherein the transparent playing surface layer comprises transparent crystal glass, transparent tempered glass or transparent acrylic.

Example 42 includes the basketball goal assembly of any one of Examples 25-41, wherein the backboard further includes a transparent back substrate layer coupled to the display opposite the transparent playing surface layer, wherein the transparent back substrate layer comprises transparent crystal glass, transparent tempered glass or transparent acrylic, and wherein the transparent back substrate layer is coupled to the display by a transparent protective clear film or crystal acrylic film.

Example 43 includes a method of selectively presenting visual content on a basketball goal assembly comprising: receiving visual content; detecting scoring events; switching a display from a transparent mode to a visual content mode in response to detection of the scoring events, wherein the display is disposed in a basketball backboard of the basketball goal assembly; and presenting the visual content in response to detection of the scoring event while the display is in the visual content mode.

Example 44 includes the method of selectively presenting visual content on a basketball goal assembly according to Example 43, wherein presenting the visual content includes outputting a portion of the visual content on the display and at least one additional portion of the visual content on one or more auxiliary displays in the visual content mode, wherein the one or more auxiliary displays are disposed on one or more edges of the basketball goal assembly.

Example 45 includes the method of selectively presenting visual content on a basketball goal assembly according to any one of Examples 43 and 44, wherein automatically detecting scoring events in real-time by a plurality of sensors comprises: detecting the scoring events by one or more primary sensors; and increasing confidence in the detected scoring events by one or more secondar sensors.

Example 46 includes the method of selectively presenting visual content on a basketball goal assembly according to any one of Examples 43-45, wherein: the one or more primary sensors comprise one or more cameras, one or more break-beam sensors or combinations thereof; and the one or more secondary sensors comprise ono or more break-beam sensors, one or more photoelectric reflective sensors, one or more smart sensors, one or more RFID sensors, one or more ultrasonic sensors or combinations thereof.

Example 47 includes the method of selectively presenting visual content on a basketball goal assembly according to any one of Example 43-46, further comprising: receiving a content schedule; and presenting the visual content in response to detection of the scoring event while the display is in the visual content mode based on the content schedule.

Example 48 includes the method of selectively presenting visual content on a basketball goal assembly according to any one or Examples 43-47, wherein: the basketball backboard includes a transparent surface layer, wherein a basketball rim is coupled to a first surface of the transparent surface layer; and the display is coupled to a second surface of the transparent surface layer opposite the first surface of the transparent surface layer.

Example 49 includes the method of selectively presenting visual content on a basketball goal assembly according to any one or Examples 43-48, wherein the display comprises a light emitting diode (LED) display or transparent holographic display.

Example 50 includes the method of selectively presenting visual content on a basketball goal assembly according to Examples 43, wherein: the scoring events are detected by one or more sensors coupled to the basketball goal assembly; and the one or more sensors comprise one or more of a camera, a break-beam sensor, a photoelectric reflective sensor, a smart sensor, an RFID sensor or an ultrasonic sensor.

Example 51 includes the method of selectively presenting visual content on a basketball goal assembly according to any one or Examples 43-50, further comprising uploading updates utilizing an application programming interface (API) or uniform resource locator (URL).

Example 52 includes the method of selectively presenting visual content on a basketball goal assembly according to any one or Examples 43-51, further comprising downloading diagnostics utilizing an application programming interface (API) or uniform resource locator (URL).

Example 53 includes a basketball goal assembly comprising: a backboard; and a rim coupled to the backboard. The backboard includes; a transparent playing surface wherein the rim is coupled to a first surface of the transparent playing surface; a display coupled to a second surface of the transparent playing surface opposite the first surface of the transparent playing surface, wherein the display includes a transparent mode and a visual content mode and wherein the display is normally in the transparent mode; one or more sensors coupled to the backboard or rim, wherein the one or more sensors detect data associated with scoring events at the basketball goal assembly; and a content controller coupled to the one or more sensors and the display, wherein the content controller detects the scoring events from the data associated with the scoring event from the one or more sensors and wherein the content controller switches the display to a visual content mode and outputs visual content on the display in response to detection of the scoring events.

Example 54 includes the basketball goal assembly of Example 53, further comprising a net coupled to the rim.

Example 55 includes a sports scoring assembly comprising: a transparent game playing surface; a game scoring element coupled to a first surface of the transparent game playing surface; a display coupled to a second surface of the transparent game playing surface opposite the first surface of the transparent game playing surface, where the display includes a transparent mode and a visual content mode; one or more sensors coupled to the game scoring element, wherein the one or more sensors detect scoring events at the game scoring element; and a content controller coupled to the one or more sensors and the display, wherein the content controller switches the display from the transparent mode to the visual content mode in response to detection of the scoring events.

Example 56 includes a basketball goal assembly comprising: a transparent backboard including a front play surface; a rim coupled to the front play surface; a display coupled to the transparent backboard opposite the rim; and a controller coupled to the display and operable to switch operation of the display from a transparent mode to a visual content mode and operable to output visual content in the visual content mode aligned with in-game events.

Example 57 includes the basketball goal assembly of Example 56, wherein outputting the visual content aligned with in-game events includes outputting the visual content in response to scoring events.

Example 58 includes the basketball goal assembly of any one of Examples 56 and 53, wherein the display comprises one of a light emitting diode (LED) display or transparent holographic display.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is intended that the scope of the invention be defined by the claims appended hereto and their equivalents.

1. A basketball goal assembly comprising:
a transparent backboard comprising a front play surface;
a rim coupled to the front play surface;
a display coupled, by a transparent protective clear film or crystal acrylic film, to the transparent backboard opposite the rim; and
a controller coupled to the display and operable to switch operation of the display from a transparent mode to a visual content mode and operable to output visual content in the visual content mode aligned with in-game events.

2. The basketball goal assembly of claim 1, further comprising:
one or more primary sensors operable to detect scoring events; and
one or more secondary sensors operable to increase confidence in the detection of the scoring events by the one or more primary sensors.

3. The basketball goal assembly of claim 1, further comprising:
one or more auxiliary displays coupled to one or more sides of the transparent backboard and display; and
the controller coupled to the display and the one or more auxiliary displays and operable to output a portion of the visual content on the display and at least one additional portion of the visual content on the one or more auxiliary displays in the visual content mode.

4. The basketball goal assembly of claim 1, wherein the in-game events comprise scoring events.

5. The basketball goal assembly of claim 1, wherein the display comprises a transparent light emitting diode (LED) display or transparent holographic display.

6. A basketball goal assembly comprising:
a backboard;
a rim coupled to the backboard;
wherein the backboard comprises;
a transparent playing surface layer wherein the rim is coupled to a first surface of the transparent playing surface layer;
a display coupled to a second surface of the transparent playing surface layer opposite the first surface of the transparent playing surface layer, wherein the display is coupled to the second surface of the transparent display by a transparent protective clear film or crystal acrylic film, and wherein the display is operable between a transparent mode and a visual content mode;
one or more sensors coupled to the backboard or rim, wherein the one or more sensors detect real-time scoring events at the basketball goal assembly; and
a content controller coupled to the one or more sensors and the display, wherein the content controller automatically switches the display from the transparent mode to the visual content mode in response to detection of the scoring events.

7. The basketball goal assembly of claim 6, further comprising:
a frame disposed along at least one edge of the backboard;
at least one auxiliary display coupled to the frame along the at least one of a top edge of the backboard; and
wherein the content controller is operable to output a portion of visual content on the display and at least one additional portion of the visual content on the at least one auxiliary display in response to detection of the scoring events.

8. The basketball goal assembly of claim 6, wherein the one or more sensors comprise:
one or more primary sensors operable to detect the real-time scoring events; and
one or more secondary sensors operable to increase confidence in the detection of the scoring events by the one or more primary sensors.

9. The basketball goal assembly of claim 8, wherein the one or more sensors comprise at least one of a camera, a break-beam sensor, photoelectric reflective sensor, smart sensor, RFID sensor or ultrasonic sensors.

10. The basketball goal assembly of claim 6, wherein the display comprises a transparent light emitting diode (LED) display or transparent holographic display.

11. The basketball goal assembly of claim 6, wherein the display outputs one or more of two-dimensional (2D) imagery, three-dimensional (3D) imagery and holographic imagery.

12. The basketball goal assembly of claim 6, wherein display of the visual content is aligned with in-game events in real-time.

13. The basketball goal assembly of claim 6, wherein the transparent playing surface layer comprises one of transparent crystal glass, transparent tempered glass or transparent acrylic.

14. The basketball goal assembly of claim 6, wherein the backboard further comprises a transparent back substrate layer coupled to the display opposite the transparent playing surface layer, wherein the transparent back substrate layer comprises one of transparent crystal glass, transparent tempered glass or transparent acrylic, and wherein the transparent back substrate layer is coupled to the display by an transparent protective clear film or crystal acrylic film.

15. A method of selectively presenting visual content on a basketball goal assembly comprising:
receiving visual content;
automatically detecting scoring events in real-time by a plurality of sensors;
switching a display from a transparent mode to a visual content mode in response to detection of the scoring events, wherein the display is disposed in a basketball backboard of the basketball goal assembly; and
presenting the visual content in response to detection of the scoring event while the display is in the visual content mode, including outputting a portion of the visual content on the display and at least one additional portion of the visual content on one or more auxiliary displays in the visual content mode, wherein the one or more auxiliary displays are disposed on one or more edges of the basketball goal assembly.

16. The method according to claim 15, wherein automatically detecting scoring events in real-time by a plurality of sensors comprises:
detecting the scoring events by one or more primary sensors; and
increasing confidence in the detected scoring events by one or more secondar sensors.

17. The method according to claim 16, wherein:
the one or more primary sensors comprise one or more cameras, one or more break-beam sensors or combinations thereof; and
the one or more secondary sensors comprise ono or more break-beam sensors, one or more photoelectric reflective sensors, one or more smart sensors, one or more RFID sensors, one or more ultrasonic sensors or combinations thereof.

18. The method according to claim 15, wherein:
the basketball backboard includes a transparent surface layer, wherein a basketball rim is coupled to a first surface of the transparent playing surface; and
the display is coupled, by a transparent protective clear film or crystal acrylic film, to a second surface of the transparent surface layer opposite the first surface of the transparent playing surface.

19. The method according to claim 15, further comprising:
receiving a content schedule; and
presenting the visual content in response to detection of the scoring event while the display is in the visual content mode based on the content schedule.

20. The method according to claim 14, wherein the display comprises a transparent light emitting diode (LED) display or transparent holographic display.
